(19) United States
(12) Patent Application Publication
(10) Pub. No.: US 2008/0235914 A1
(43) Pub. Date: Oct. 2, 2008

(54) Portable Hanger For Use in Public Transportation

(75) Inventor: Stanley H. Dolberg, Cambridge, MA (US)

Correspondence Address: GUERIN & RODRIGUEZ, LLP, 5 MOUNT ROYAL AVENUE, MOUNT ROYAL OFFICE PARK, MARLBOROUGH, MA, 01752, US

(73) Assignee: THE TRANSTRAP CORPORATION, Cambridge, MA (US)

(21) Appl. No.: 12/063,877

(22) PCT Filed: Aug. 22, 2006
(86) PCT No.: PCT/US06/32832

§ 371 Date: Feb. 15, 2008

Related U.S. Application Data
(60) Provisional application No. 60/711,317, filed on Aug. 25, 2005.

(51) Int. Cl. B25G 1/10

(52) U.S. Cl. 16/430; 16/110.1

(57) ABSTRACT

Described are portable hangers and methods for constructing same. A portable hanger includes a strap member with a first end shaped into a hook and with a second end shaped into a handhold-sized loop. The first end of the strap has a friction-enhancing surface within an inner arc of the hook. To construct a portable hanger, in one embodiment, a hook is inserted into an open first end of a strap. The open first end of the strap is closed to enclose completely the hook within the first end of the strap. A second end of the strap is attached to an intermediate section of the strap to form a handhold-sized loop.

### RELATED APPLICATION

This application claims the benefit of the filing date of U.S. Provisional Application Ser. No. 60/711,317, filed Aug. 25, 2005, titled “Hanger,” the entirety of which provisional application is incorporated by reference herein.

### FIELD OF THE INVENTION

The invention relates generally to hangers. More specifically, the invention relates to a portable hanger for use in public transportation.

### BACKGROUND

Public transportation vehicles, such as trains and busses, are often crowded, especially during rush hour. Often, commuters or riders must stand during the ride. Such riders typically hold onto fixed hangers, overhead bars, or vertical poles located within the vehicle to steady themselves. One drawback to such permanent supports is that they can carry and spread illness-causing germs among those riders who touch them. Moreover, the height of an overhead bar may pose a problem for people who are short in stature and consequently unable to reach an available hanger. The problem worsens if the vehicle is crowded and the person needs to reach around or over another rider. Embarrassed or intimidated, the person may choose not to hold onto anything rather than attempt to grab the hanger. By so doing, that person subjects himself and others to injury should the vehicle stop suddenly.

To address such problems, innovators have devised various types of hangers. However, some of these hangers can be difficult to use quickly in the hustle and bustle of commuting (i.e., they require too much time to attach and detach from the overhead bars, hanger or poles); others are ineffectual to prevent slipping when used with the stainless steel bars commonly employed in public transportation; others can be too heavy for convenient use and carriage; and others have exposed metal or wood components that can cause injury if the hanger is dropped or comes into contact with another rider.

### SUMMARY

In one aspect, the invention features a hanger comprising a strap member with a first end shaped into a hook and with a second end shaped into a handhold-sized loop. The first end of the strap has a friction-enhancing surface within an inner arc of the hook.

In another aspect, the invention features a hanger with a strap having a first end and a second end. The first end of the strap is folded over and attached to the strap to form a pocket, and the second end of the strap is folded over and attached to the strap to form a handhold-sized loop. A hook is completely enclosed within the pocket at the first end of the strap. In still another aspect, the invention features a method for constructing a portable hanger comprising the step of attaching a first end of a strap to an intermediate section of the strap to form a pocket. A hook is inserted into the pocket to form a hooked end of the hanger. A second end of the strap is attached to another intermediate section of the strap to form a handhold-sized loop.

In still yet another aspect, the invention features a method for constructing a portable hanger comprising the step of inserting a hook into an open first end of a strap. The open first end of the strap is closed to enclose completely the hook within the first end of the strap. A second end of the strap is attached to an intermediate section of the strap to form a handhold-sized loop.

### BRIEF DESCRIPTION OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a perspective view of a first illustrative embodiment of a hanger.

FIG. 2 is a cross-sectional view of the hanger of FIG. 1 along the line 2-2 showing a rigid hook disposed between a material blank.

FIG. 3 is a perspective view of the rigid hook of FIG. 2.

FIG. 4 is a side elevation view of the hanger of FIG. 1 in a folded position.

FIG. 5 is a perspective view of the hanger of FIG. 1 with the hand of a rider (drawn in phantom) holding the hanger.

FIG. 6 is a perspective view of another illustrative embodiment of a hanger having a clasp for receiving objects.

FIG. 7 is a front elevation view of an embodiment of a pass holder.

FIG. 8 is a perspective view of an embodiment of a reader sling.

FIG. 9 is a perspective view of the reader sling of FIG. 8 coupled to the hanger and in use by a rider shown in phantom.

FIG. 10 is a perspective view of an embodiment of a loop sleeve.

FIG. 11 is a perspective view of the loop sleeve of FIG. 10 removably attached to the hanger of FIG. 1.

FIG. 12 is a flow chart of an embodiment of a process for constructing the hanger of FIG. 1.

FIGS. 13A-13F are diagrams illustrating stages of the hanger construction of FIG. 12.

FIG. 14 is a perspective view of another illustrative embodiment of a hanger.

FIG. 15 is a flow chart of an embodiment of a process for constructing the hanger of FIG. 14.

FIGS. 16A-16E are diagrams illustrating stages of the hanger construction of FIG. 15.

### DETAILED DESCRIPTION

Portable hangers constructed in accordance with the present invention give riders of public transportation an alternative to reaching uncomfortably for or holding directly onto potentially unsanitary hangers, overhead bars, and vertical poles when standing in the vehicle. In general, such portable hangers are lightweight, and fold for easy and convenient carrying and storing in a pocket, briefcase, purse, or carrying bag. Being personally owned and washable, the hangers are sanitary. In the course of entering or leaving a vehicle, a rider can easily and quickly place the hanger onto, and remove the hanger from, an overhead bar. The firmness of a hook end of the hanger can give additional reach to anyone reaching for the overhead bar. The hook end also has a friction-enhancing surface that “grips” the overhead bar to prevent or reduce slipping of the hanger.

Embodiments of the portable hanger can be used with various accessories, including a loop sleeve that wraps around a loop end of the hanger to provide a cushion for a comfortable and decorative handhold. Another accessory includes a pouch (or holder) that couples to the hanger and holds an object such as, but not limited to, a commuter pass, a camera, a radio, an umbrella, and a key tag. Another accessory includes a sling that couples to the hanger and enables a rider to read a book, a newspaper, or a publication, comfortably, while standing in the vehicle.

FIG. 1 shows an embodiment of a hanger 10 constructed in accordance with the invention. The hanger 10 includes a continuous length of material blank 12 (referred to hereafter as strap 12). Materials of which the strap 12 may be fabricated include, but are not limited to, nylon, nylon webbing, rayon, Orlon®, rubber, cotton, leather, vinyl, and plastic. Preferably, the material used for the strap 12 is washable.

The strap 12 has a first end 14 and a second end 16. The first end 14 folds back over and attaches to the strap 12 to define a pocket 15. Stitches 18, e.g., of nylon thread, can attach the first end 14 to the strap 12. The pocket 15 receives a rigid hook 24 (FIG. 3), to reinforce the strap 12 and to form a hook end 19 of the hanger 10. The length of the arc of the hook 24 can vary to increase or decrease the ease with which the hook end 19 can be placed over and removed from an overhead bar. The pocket 15 completely encloses the hook 24 so that no portion of the hook 24 remains exposed. Fully enclosing the hook 24 within the pocket 15, for example, is a safety-related benefit of the hanger 10; by not exposing the rigid reinforcing hook, riders are less subject to injury should the hanger 10 be inadvertently dropped onto or strike another rider.

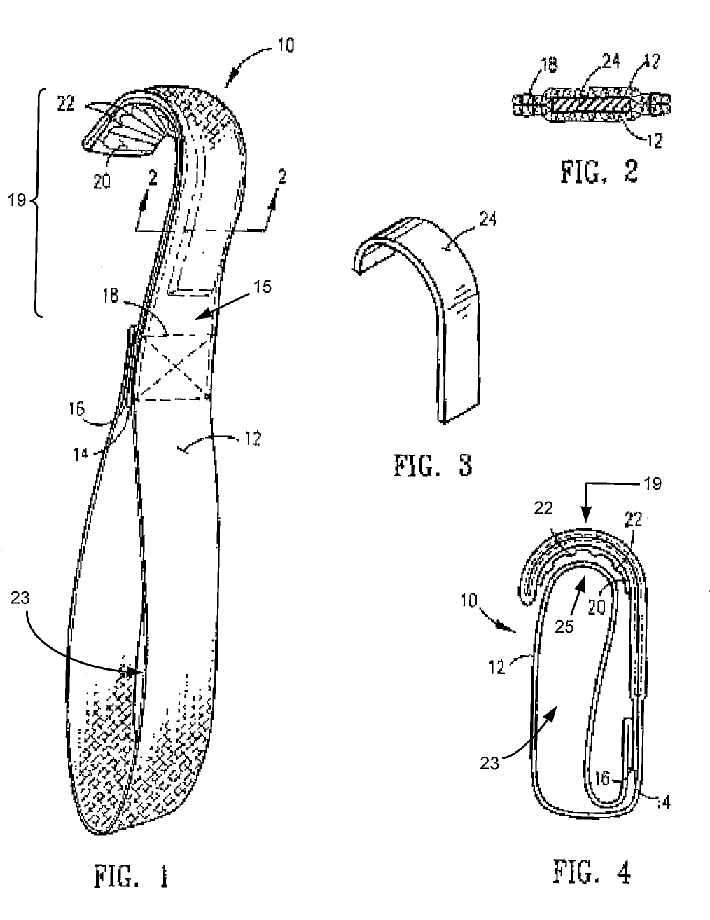

FIG. 2 shows a cross section of the hanger 10 along the line 2-2 in FIG. 1, with the rigid hook 24 disposed in the pocket 15 between the folded sections of the strap 12. Examples of material of which the rigid hook 24 can be made include, but are not limited to, aircraft aluminum, plastic, and steel. In one embodiment, an inner arc of the hook 24 has a radius of about three-quarters of an inch—this size accommodates many standard overhead bars (1¼-inch diameters) and handicap railings (1½-inch diameters) used in public transportation. Other radii may be used without departing from the principles of the invention.

Referring again to FIG. 1, friction-enhancing material 20 is disposed on the strap 12 at the hook end 19. Examples of materials for implementing the friction-enhancing material 20 include, but are not limited to, fabrics (such as polyester, nylon tricot) coated with neoprene, vinyl, or other friction-enhancing material, rubberized fabrics, rubber-coated polymers, and elastomeric materials. In one embodiment, the friction-enhancing material 20 is sewn to the strap 12. In another embodiment, chemical deposition can be used to apply the friction-enhancing material 20 to the strap 12. Other techniques for applying a layer of friction-enhancing material 20 to the hook end 19 include gluing and spraying. In still another embodiment, the strap 12 is made of friction-enhancing material (at least at the hook end 19), and adding friction-enhancing material to the hook end 19 is optional.

The friction-enhancing material 20 is disposed on the side of the strap 12 that becomes the inner arc or curve of the hook end 19 after the hook 24 is inserted into the pocket 15. During the process of inserting the hook 24 into the pocket 15, the friction-enhancing material 20 gathers (i.e., wrinkles or creases) along the inner arc of the hook end 19, thus creating projections 22 that enhance the friction (and prevent slippage) between the friction-enhancing material 20 and an overhead bar. Most overhead bars are scored (i.e., have scratches or grooves) with which the projections 22 can rub to improve the grip of the hook end 19 of the hanger 10 with the overhead bar.

The second end 16 of the strap 12 folds over and attaches to the strap 12 to form a handhold-sized loop 23. Stitches 18, e.g., of nylon thread, can attach the second end 16 to the strap 12. In one embodiment, the second end 16 of the strap 12 overlaps and becomes attached to the first end 14 of the strap 12, and the stitches 18 secure the two ends 14, 16 to each other. The stitches 18 can also operate to seal the pocket 15 in which the hook 24 is enclosed. FIG. 4 shows a side view of the hanger 10, with the strap loop 23 folded such that the loop end 25 fits within the inner curve of the hook end 19. In this folded position, the hanger 10 compactly folds for carrying or storage. Hangers, in general, are lightweight, ranging from about 1½ to 3 ounces. In an unfolded position, embodiments of the hanger 10 have lengths typically ranging from about nine to thirteen inches, measured from the hook end 19 to the loop end 25. Hangers of other weights and lengths may be constructed without departing from the principles of the invention. The rigid construction of the hanger 10, as described in more detail below, serves to give the rider additional reach for grabbing an overhead bar.

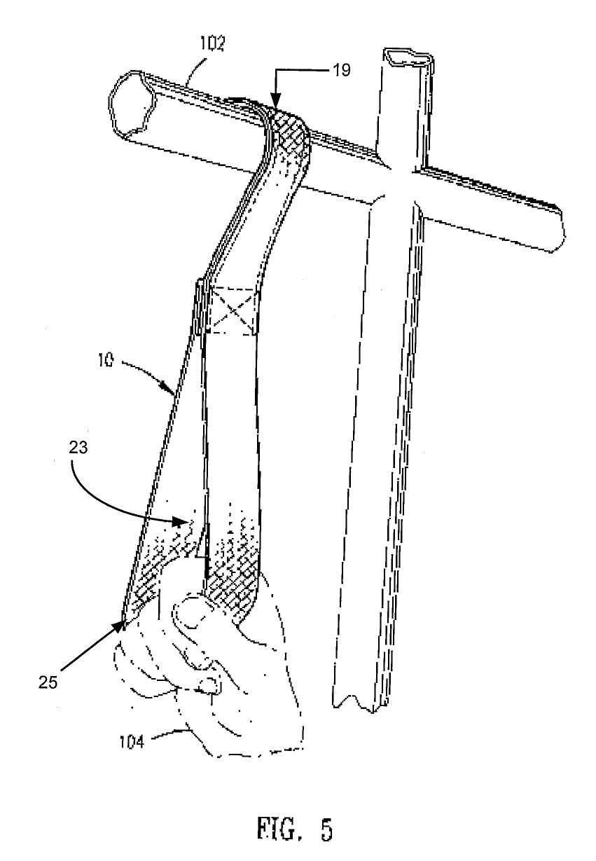

FIG. 5 shows an example of the hanger 10 in use. The hook end 19 of the hanger 10 drapes over an overhead bar 102 within a vehicle, such as a cable car, streetcar, train, or bus. As noted above, the size of the arc of the hook end 19 is such that the hook end 19 closely receives the overhead bar 102. A hand 104 (in phantom) of a rider passes through the strap loop 23 and grasps the hanger 10 at the loop end 25. While riding in the vehicle, the hand of the rider normally pulls the hanger 10 down (assisted by gravity). The friction-enhancing material 20 and projections 22 compress against the overhead bar 102 to provide a slip-resistant grip. To remove the hanger 10 from the overhead bar 102, the rider, still holding the loop end 25, lifts the hook end 19 slightly above the overhead bar 102.

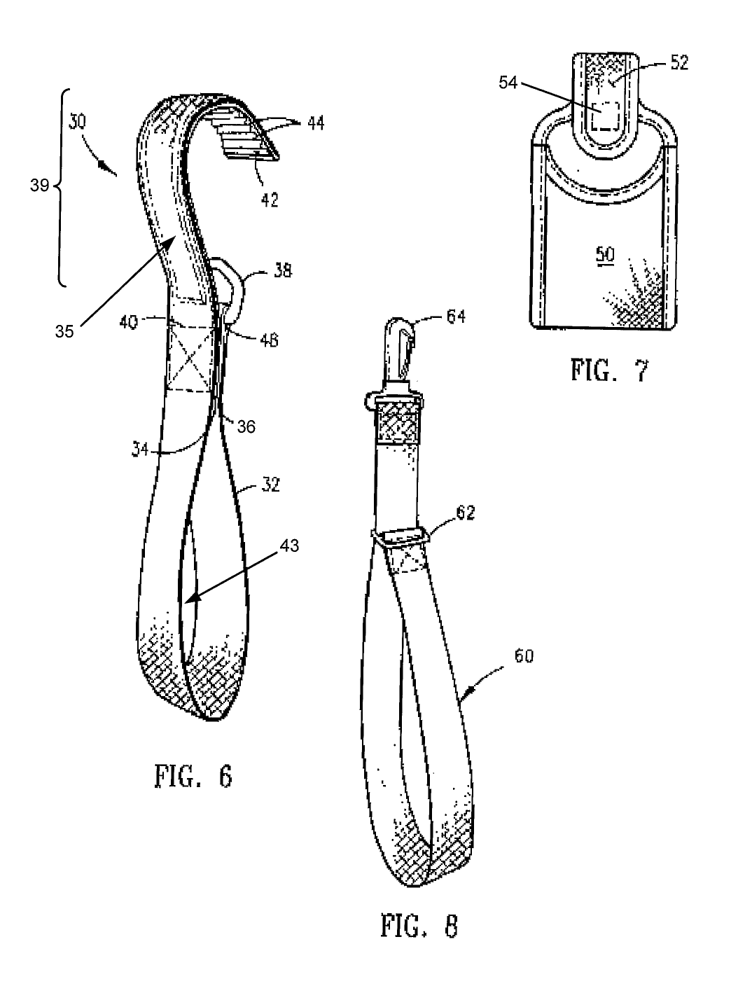

FIG. 6 shows another illustrative embodiment of a hanger 30 constructed in accordance with the invention. The hanger 30 includes a unitary (i.e., continuous) strap 32. The strap 32 has a first end 34 and a second end 36. The first end 34 folds back over and attaches to the strap 32 to define a pocket 35. Stitches 40, e.g., of nylon thread, can attach the first end 34 to the strap 32. The pocket 35 receives a rigid hook—not visible; the pocket 35 completely encloses the hook—to form a hook end 39 of the hanger 30.

Friction-enhancing material 42 is disposed on the strap 32 at the hook end 39. The friction-enhancing material 42 is disposed on the side of the strap 32 that becomes the inner arc of the hook end 39 and has projections 44 (e.g., produced when the material 42 gathers when the hook is inserted into the pocket 35). The projections 44 enhance the friction (and prevents slippage) between the friction-enhancing material 42 and an overhead bar.

The second end 36 of the strap 32 folds over twice before attaching to the strap 32. The first fold of the second end 36 of the strap 32 forms a handhold-sized loop 43. The second fold forms a ring loop 48. Stitches 40 can attach the second end 36 to the strap 32. In one embodiment, the second end 36 of the strap 32 overlaps and attaches to the first end 34 of the strap 32, and the stitches 40 secure the two ends 34, 36 to each other. A ring 38 (e.g., a plastic-coated steel D-ring) passes through the ring loop 48. The ring 38 can be used to couple an accessory or other types of objects, such as radios, cameras, an umbrella, a key tag, to the hanger 30, as described in more detail below.

Materials of which the strap 32, stitches 40, and friction-enhancing material 42 may be fabricated and methods in which the hook end 39, handhold-sized loop 43, and friction-enhancing material 42 may be constructed are similar to those described above for the hanger 10.

FIG. 7 shows an example of an accessory, here, a pass holder 50 with a strap 52 having a fastener 54 for coupling the strap 52 to the hanger 30. With the strap 52 passed through the ring 38 of the hanger 30, the fastener 54 detachably secures the strap 52 to the body of the pass holder 50. Embodiments of the fastener 54 include, but are not limited to, a hook and loop-type fastener, and a snap button and buckle. In one embodiment, transit passes of standard credit card size fit closely into the pass holder 50. The pass holder 50 may be fabricated from nylon-covered neoprene, making it rugged, yet lightweight.

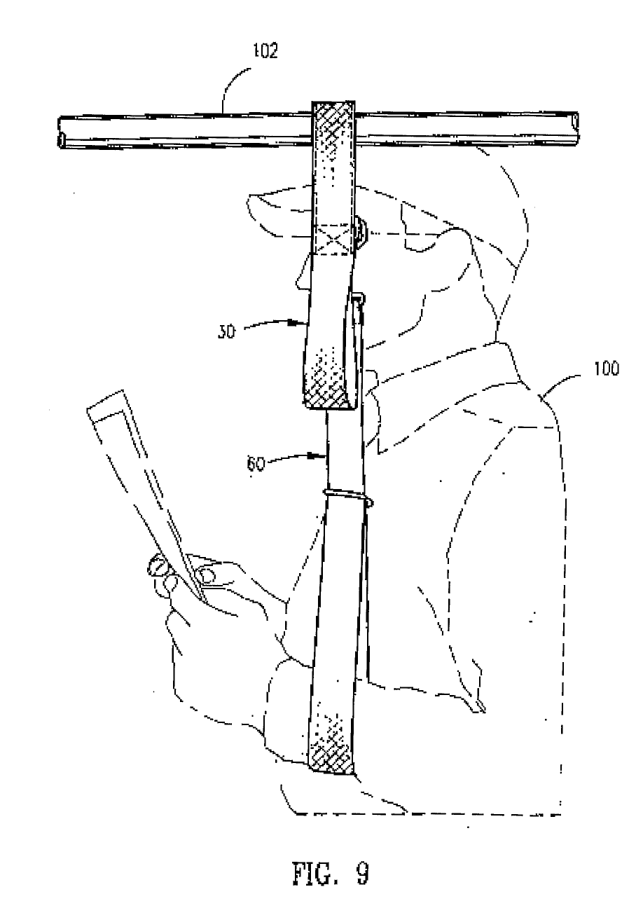

FIG. 8 shows another example of an accessory, here, a reader sling 60, that can be coupled to the ring 38 of the hanger 30. The reader sling 60 has a fastener 64 that clips onto the ring 38 of hanger 30 and an adjuster 62 for varying the length of the reader sling 60. In one embodiment, the reader sling 60 is washable, being made of plush heavy-duty nylon webbing. A shown in FIG. 9, the reader sling 60 enables a rider 100 to read while standing in the vehicle. The hanger 30 drapes over the overhead bar 102, the reader sling 60—being coupled to the ring 38—depends from the hanger 30, and the arm of the rider 100 slips through and rests on the reader sling 60. Thus, the rider 100 can read with two hands while tethered to the overhead bar 102.

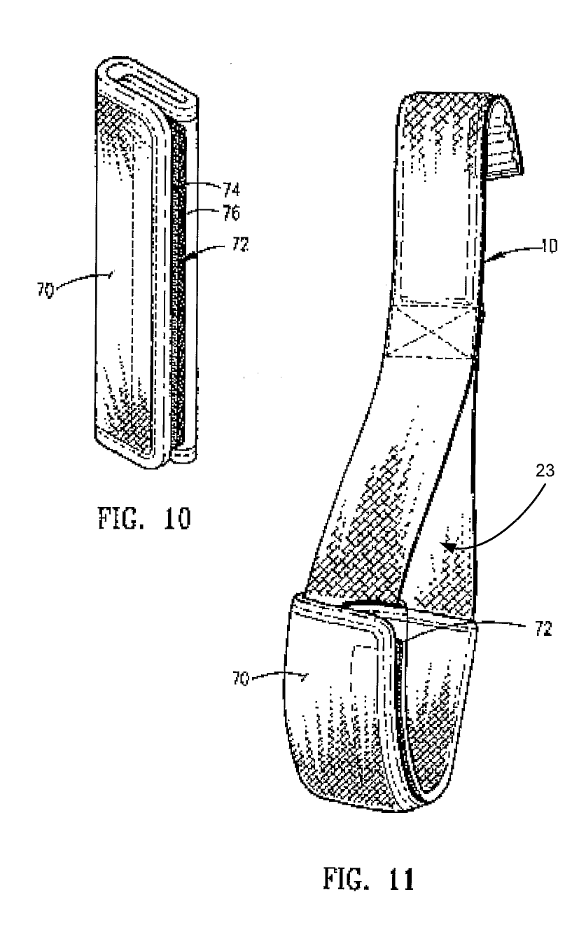

FIG. 10 shows an embodiment of a loop sleeve 70 (in a folded and closed position). The loop sleeve 70 has a fastener 72, preferably with a hook fastener 74 and a loop fastener 76, disposed on the loop sleeve 70. In one embodiment, the loop sleeve 70 is made of nylon-covered neoprene. FIG. 11 shows the loop sleeve 70 detachably wrapped and fastened around a section of the loop end 25. When attached to the loop end of the hanger 10, the loop sleeve 70 adds cushioning, decoration, and flair, and is easily detachable for washing. It is to be understood that the loop sleeve 70 can also be used with other hangers, including the hanger 30.

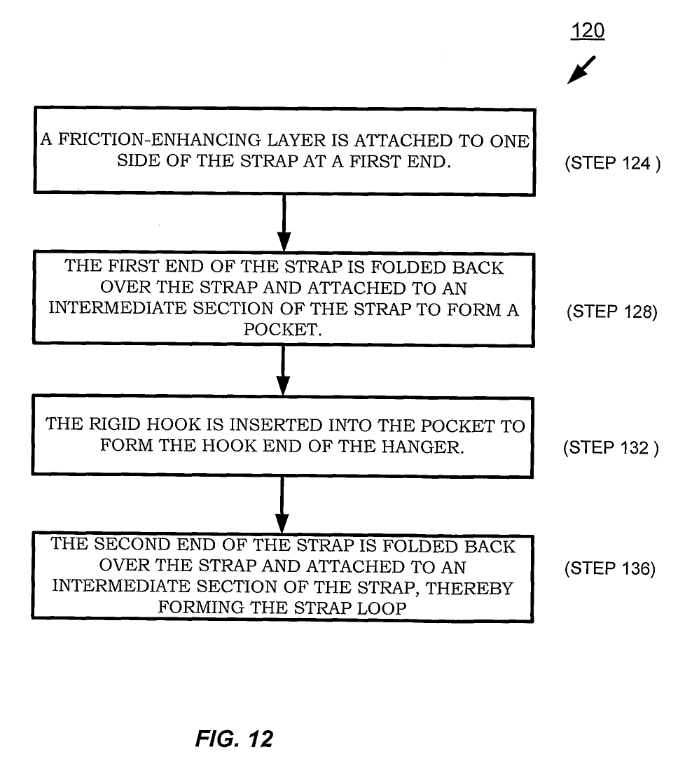

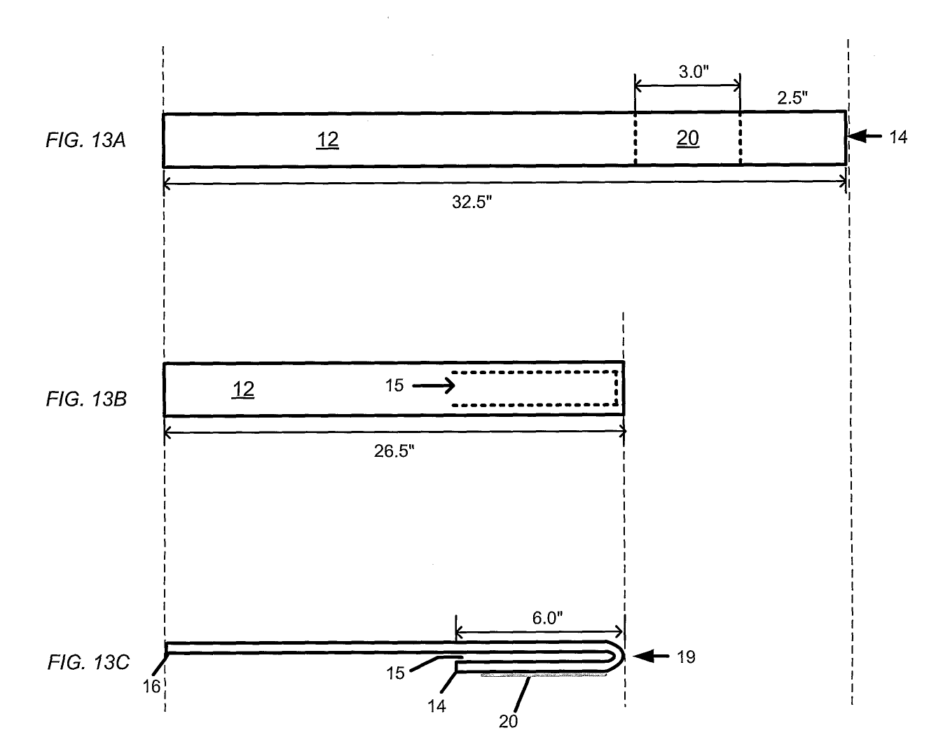

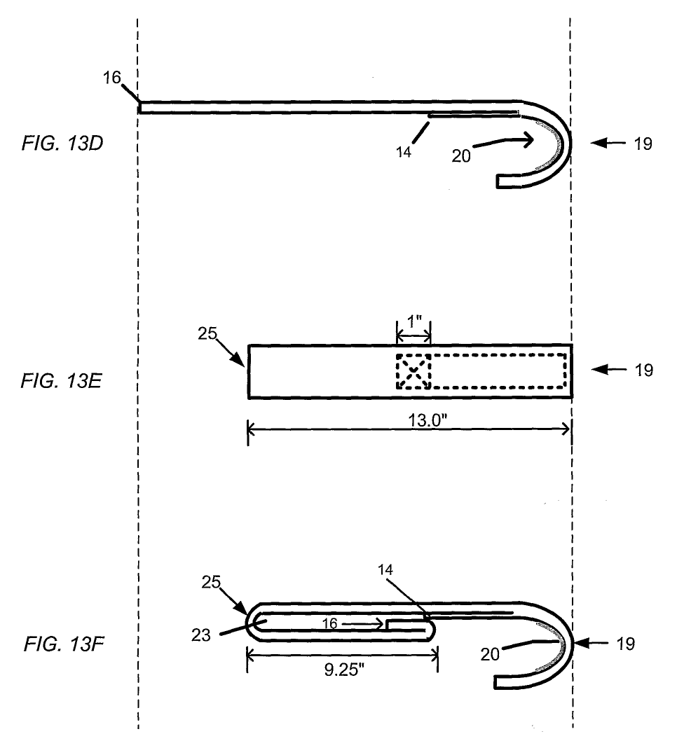

FIG. 12 shows an embodiment of a process 120 for constructing an embodiment of a hanger. In the description of the process, reference is also made to FIGS. 13A-13F. In addition, the presented order of steps is exemplary; some steps of the construction process can occur in a different order when constructing the hanger. Any dimensions provided in FIGS. 13A-13F are exemplary. At step 124, friction-enhancing material 20 is added to one side of the strap 12 at a first end 14, as shown in FIG. 13A. For example, the material 20 may be sewn to the strap 12 (in FIGS. 13A-13F, stitches are shown as dashed lines). In one embodiment, the friction-enhancing material 20 is 3 inches in length and is attached 2.5 inches from the end of the strap 12.

At step 128, the first end 14 of the strap 12 is folded back over the strap 12 and sewn along the edges of the strap 12 to form a pocket (or sleeve) 15, as shown in a top view of FIG. 13B. In one embodiment, the length of the folded back section of the strap 12 is 6.0 inches, as shown by the side view of FIG. 13C. In FIG. 13C, the friction-enhancing material 20 is on the exterior-facing surface of the folded back section.

At step 132, the rigid hook 24 is inserted, curved end first, into the pocket 15 to form the hook end 19 of the hanger 10, as shown in the side view of FIG. 13D. The orientation of the hook 24 within the pocket 15 is such that the friction-enhancing material 20 becomes disposed along the inner arc of the hook end 19. Inserting the hook 24 into the pocket 15 and working the hook 24 to the stitched end of the pocket 15 causes the friction-enhancing material 20 to gather, thus forming projections 22 (not shown).

At step 136, the second end 16 of the strap 12 is folded twice and attached to the strap 12 at the bottom of the hook, as shown in the top view of FIG. 13E, thereby forming the handhold-sized loop 23, as shown in the side view of FIG. 13F. In the embodiment shown, the second end 16 overlaps the first end 14. The steps of attaching the ends 14, 16 to the intermediate section of the strap 12 can occur simultaneously (i.e., the stitches 18 pass through the overlapped strap ends 14, 16).

Fabrication of the hanger 30 (FIG. 6) is similar to that of the hanger 10, with an additional step of passing the second end 36 of the strap 32 through the ring 38 when folding the second end 36 of the strap 32 for the second time. Thus, a small ring loop 48 (for holding the ring) is formed before the second end 36 is attached to the strap 32.

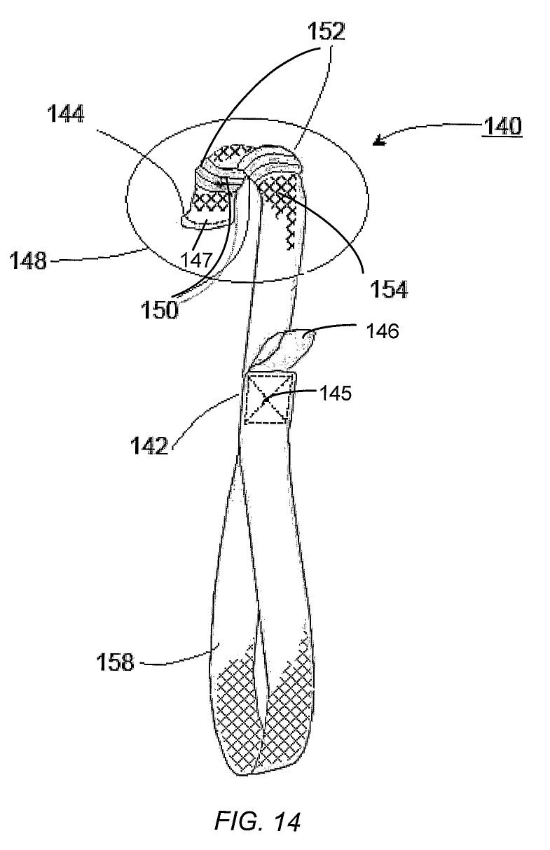

FIG. 14 is a perspective view of another illustrative embodiment of a hanger 140 constructed in accordance with the invention. The hanger 140 includes a continuous strap 142. In this embodiment, the strap 142 is made of tubular nylon (e.g., 1 inch in width). National Webbing Products of Garden City, N.Y., produce tubular nylon straps that can be used to construct the hanger 140. Tubular nylon material is generally flat and open at each end (here, referred to as first and second ends 144, 146, respectively).

Similar to the embodiments of hangers 10, 30 described above, the second end 146 of the strap 142 folds over and attaches to the strap 142 to form a handhold-sized loop 158. The stitches 145 that attach the second end 146 to an intermediate section of the strap 142 can also operate to close the second end 146 of the nylon tubing.

A rigid hook (e.g., hook 24 of FIG. 3) slides completely into the first end 144 so that no portion of the hook remains exposed, thereby forming a hook end 148 of the hanger 140. In one embodiment, a ¾-inch, 6-inch long stamped metal hook fits closely within a 1-inch tubular nylon strap. Nylon stitches 147 can be used to close the first end 144 after the hook is inserted.

To provide a friction-enhancing surface 150 on an inner arc of the hook end 148, in one embodiment one or more continuous coils of a polyurethane rod 152 encircles the first end 144 (enlarged by the hook). In another embodiment, the friction-enhancing surface 150 includes one or more o-rings (not shown) that are slipped over the enlarged first end 144. Typically, the weave of the tubular nylon strap 142 has lateral grooves 154 into which the o-rings or polyurethane coil can sit. Polyurethane coils and o-rings may be available in a variety of colors, to allow riders to customize the appearance of the hanger 140 to suit their tastes.

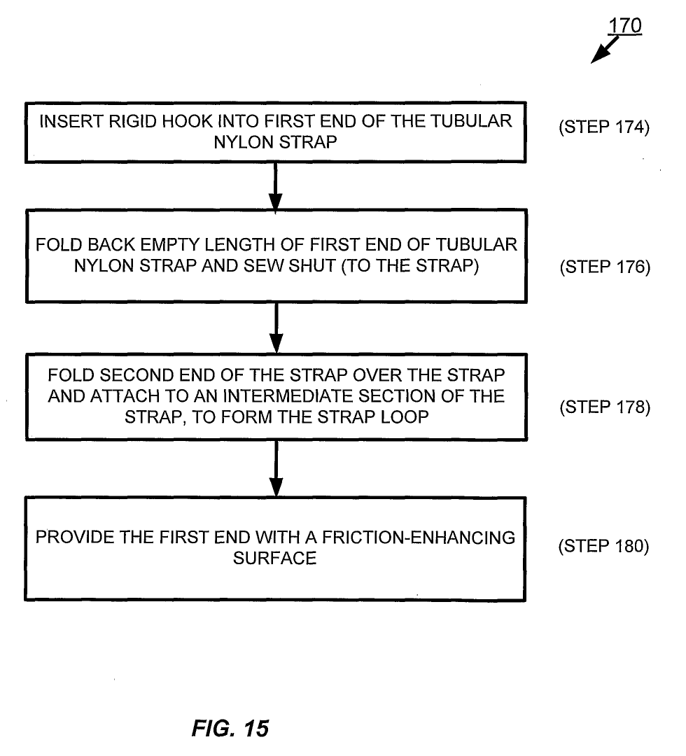

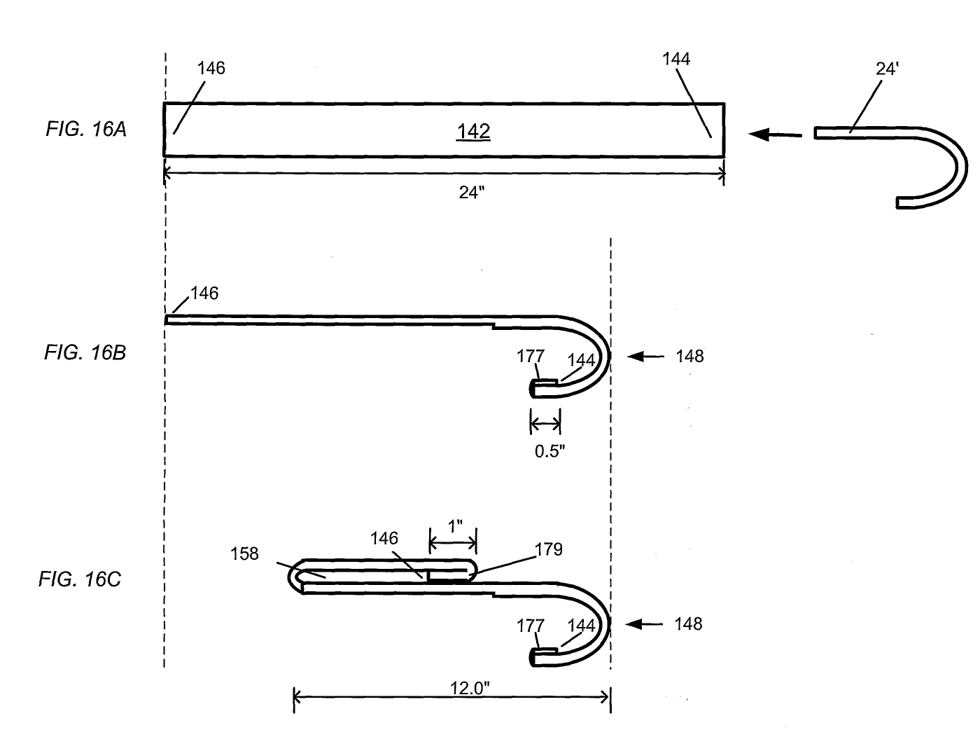

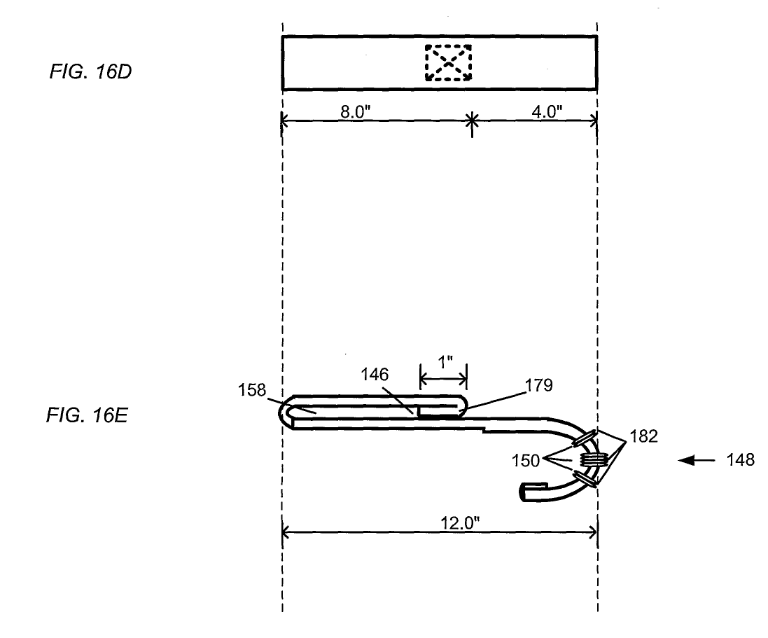

FIG. 15 is a flow chart of an embodiment of a process 170 for constructing the hanger of FIG. 14. In the description of the process 170, reference is also made to FIGS. 16A-16E. In addition, the presented order of steps is exemplary; some steps of the process can occur in a different order when constructing the hanger 140. Any dimensions provided in FIGS. 16A-16E are exemplary.

At step 174, the longer arm of a rigid hook 24′ is inserted into the open first end 144 of the strap 142, as shown in FIG. 16A. The hook is inserted a sufficient distance into the nylon tubing so that approximately one inch of nylon tubing remains empty at the first end 144. At step 176, this empty length of nylon tubing is folded over and sewn shut to an inner side (i.e., within the arc of the hook) of the strap 142, as shown in the side view of FIG. 16B. Other mechanisms for closing the first end 144 can be used without departing from the invention (e.g., using hook-and-loop fasteners, folding and sewing the first end 144 to an exterior side of the strap 142, sewing shut the first end 144 without folding the nylon tube).

At step 178, a length of nylon tubing at the second end 146 of the strap 142, e.g., 1 inch, is folded over in a direction opposite the bend of the hook 24′, and attached to the strap 142, thereby forming the strap loop 158, as shown in the side view of FIG. 16C. The second end 146 can have a second fold 179 before it is attached to the strap 142. In one embodiment, the point of attachment is snug against the end of the hook 24′ (shrouded within the first end 144 of the strap 142). FIG. 16D shows a top view of the hanger 140 after the second end 146 is sewn to the strap 142. Optionally, the hanger 140 can be constructed with an accessory ring, similar to that described in FIG. 6 in connection with the hanger 30.

At step 180, the first end 144 is provided with a friction-enhancing surface 150 (e.g., by wrapping a polyurethane coil around or sliding one or more o-rings over the first end 144 of the strap 142). For example, FIG. 16E shows a plurality of o-rings 182 around the hook end 148 of the hanger 140.

Although the invention has been shown and described with reference to specific preferred embodiments, it should be understood by those skilled in the art that various changes in form and detail may be made therein without departing from the spirit and scope of the invention as defined by the following claims. For example, the embodiments of portable hangers described herein are constructed of a unitary (i.e. a single, continuous) strap. Other embodiments of hangers can have multiple, separate lengths of straps (made of the same or of different materials) that, for example, are sewn together. In addition, although the various embodiments have the hook curving on the same side of where one end of the strap is attached to the intermediate section of the strap to form the handhold-sized loop, other embodiments can have the hook and the point of attachment on opposite sides.

What is claimed is:

1. A portable hanger comprising a strap member with a first end shaped into a hook and with a second end shaped into a handhold-sized loop, the first end of the strap having a friction-enhancing surface within an inner arc of the hook.

2. The hanger of claim 1, wherein the friction-enhancing surface includes a layer of friction-enhancing material.

3. The hanger of claim 1, wherein the friction-enhancing surface includes one or more projections extending therefrom.

4. The hanger of claim 1, further comprising at least one o-ring around the hook-shaped first end to provide the friction-enhancing surface.

5. The hanger of claim 1, further comprising at least coil wrapped around the hook-shaped first end that provides the friction-enhancing surface.

6. The hanger of claim 1, wherein the first end of the strap member has a pocket within which reinforcing material is disposed.

7. The hanger of claim 6, wherein the reinforcing material is a metal J-hook.

8. The hanger of claim 1, further comprising a ring coupled to the strap member at a location between the first end and the second end.

9. The hanger of claim 8, further comprising a sling detachably coupled to the ring.

10. The hanger of claim 8, further comprising a pass holder detachably coupled to the ring.

11. The hanger of claim 1, further comprising a loop sleeve detachably wrapped around a section of the handhold-sized loop.

12. The hanger of claim 1, wherein the strap member is a unitary, continuous length of material.

13. The hanger of claim 12, wherein the strap member is a length of tubular nylon.

14. The hanger of claim 1, wherein the strap member includes a plurality of attached lengths of material.

15. A hanger, comprising:
a strap with a first end and a second end, the first end of the strap being folded over and attached to the strap to form a pocket and the second end of the strap being folded over and an attached to the strap to form a handhold-sized loop; and
a hook completely enclosed within the pocket at the first end of the strap.

16. The hanger of claim 15, wherein the pocket has a friction-enhancing surface.

17. The hanger of claim 16, wherein the friction-enhancing surface includes a neoprene-coated polyester fabric.

18. The hanger of claim 16, wherein the friction-enhancing surface includes one or more projections extending therefrom.

19. The hanger of claim 15, wherein the hook is a metal J-hook.

20. The hanger of claim 15, further comprising a ring coupled to the strap at a location between the handhold-sized loop and the pocket with the hook.

21. The hanger of claim 20, further comprising a sling detachably coupled to the ring.

22. The hanger of claim 20, further comprising a pass holder detachably coupled to the ring.

23. The hanger of claim 15, further comprising a loop sleeve detachably wrapped around a section of the handhold-sized loop.

24. The hanger of claim 15, wherein the strap is a unitary, continuous length of material.

25. The hanger of claim 15, wherein the strap member includes a plurality of attached lengths of material.

26. A method for constructing a portable hanger comprising:
attaching a first end of a strap to an intermediate section of the strap to form a pocket;
inserting a hook into the pocket to form a hooked end of the hanger; and
attaching a second end of the strap to another intermediate section of the strap to form a handhold-sized loop.

27. The method of claim 26, further comprising the step of attaching friction-enhancing material at the first end of the strap to give the hanger a friction-enhancing surface.

28. The method of claim 27, wherein the step of attaching friction-enhancing material at the first end of the strap occurs before inserting the hook into the pocket.

29. The method of claim 26, further comprising the steps of forming a second loop at the second end of the strap and passing a ring therethrough.

30. A method for constructing a hanger comprising:
inserting a hook into an open first end of a strap;
closing the open first end of the strap to enclose completely the hook within the first end of the strap; and
attaching a second end of the strap to an intermediate section of the strap to form a handhold-sized loop.

31. The method of claim 30, further comprising the step of providing the first end of the hanger with a friction-enhancing surface.

32. The method of claim 31, wherein the step of providing the first end with a friction-enhancing surface occurs before the hook is inserted into the open first end of the strap.

33. The method of claim 31, wherein the step of providing the first end with a friction-enhancing surface includes wrapping a polyurethane coil around the first end.

34. The method of claim 31, wherein the step of providing the first end with a friction-enhancing surface includes sliding one or more o-rings over the first end.
